(19) United States
(12) Patent Application Publication
(10) Pub. No.: US 2008/0150982 A1
(43) Pub. Date: Jun. 26, 2008

(54) Printer motor detection and control

(76) Inventor: Brian A. Reichert, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/614,289

(22) Filed: Dec. 21, 2006

(51) Int. Cl. B41J 29/38

(52) U.S. Cl. 347/11; 347/14

(57) ABSTRACT

The present disclosure describes printer motor detection and control. One exemplary method may generating a first printer motor voltage and a second printer motor voltage and supplying said first printer motor voltage and a second printer motor voltage to a printer motor; detecting a first printer motor speed corresponding to the first printer motor voltage and a second printer motor speed corresponding to the second printer motor voltage; determining at least one physical characteristic of the printer motor based on, at least in part, the first motor speed and said second motor speed; and controlling the operation of the printer motor based on, at least in part, the at least one physical parameter of the printer motor. Of course, many variations and modifications are possible without departing from this embodiment.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

This disclosure relates to motor detection and control and, more particularly, to printer motor detection and control for use in a modular printer system.

2. Description of the Related Art

A printer may include modular components that may be interchangeable with other printers. For example, a laser printer may include a fuser packaged as a customer replaceable unit (CRU) that can be installed in other laser printers. The CRU may include a fuser motor to drive the fuser mechanism. While the overall operation of the CRU may be similar when switched to another printer, control of the fuser motor may differ between printers. Likewise, the fuser motor may be changed within a given CRU package such that, when used interchangeably with different laser printers, may present motor control problems.

### SUMMARY OF THE INVENTION

An aspect of the present disclosure relates to a printer. The printer may include a motor and a print engine. The print engine may be configured to generate a first motor voltage and a second motor voltage, detect a first motor speed of the motor corresponding to the first motor voltage and a second motor speed of the motor corresponding to the second motor voltage. In addition, the print engine may be configured to determine at least one physical characteristic of the motor based on, at least in part, the first motor speed and the second motor speed. Furthermore, the print engine may be configured to control the operation of the motor based on, at least in part, at least one physical parameter of the motor.

Another aspect of the present disclosure relates to a method for determining a motor type installed in a printer. The method may include generating a first printer motor voltage and a second printer motor voltage and supplying the first printer motor voltage and the second printer motor voltage to a printer motor. The method may also include detecting a first printer motor speed corresponding to the first printer motor voltage and a second printer motor speed corresponding to the second printer motor voltage. Furthermore the method may include determining at least one physical characteristic of the printer motor based on, at least in part, the first motor speed and the second motor speed and controlling the operation of the printer motor based on, at least in part, the at least one physical parameter of the printer motor.

A further aspect of the present disclosure relates to an article comprising a storage medium having stored thereon instructions that when executed by a machine result in generating a first printer motor voltage and a second printer motor voltage and supplying the first printer motor voltage and the second printer motor voltage to a printer motor. In addition, the instructions stored thereon when executed by a machine may also result in detecting a first printer motor speed corresponding to the first printer motor voltage and a second printer motor speed corresponding to the second printer motor voltage. Furthermore, the instructions stored thereon when executed by a machine may also result in determining at least one physical characteristic of the printer motor based on, at least in part, the first motor speed and the second motor speed and controlling the operation of the printer motor based on, at least in part, the at least one physical parameter of the printer motor.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a diagram of a printer system according to one exemplary embodiment of the present disclosure;

FIG. 2 is a graph of motor speed (ω) as a function of PWM duty cycle settings (p) according to one exemplary embodiment of the present disclosure;

FIG. 3 is a graph of PWM duty cycle settings (p) as a function of time (t) according to one exemplary embodiment of the present disclosure;

FIG. 4 is a graph of generated back-EMF data for two different printer motors according to one embodiment of the present disclosure;

FIG. 5 is a graph of generated back-EMF data for two different printer motors according to another embodiment of the present disclosure; and

FIG. 6 is a flowchart of operations according to one embodiment of the present disclosure.

Although the following Detailed Description will proceed with reference being made to illustrative embodiments, many alternatives, modifications, and variations thereof will be apparent to those skilled in the art.

### DETAILED DESCRIPTION

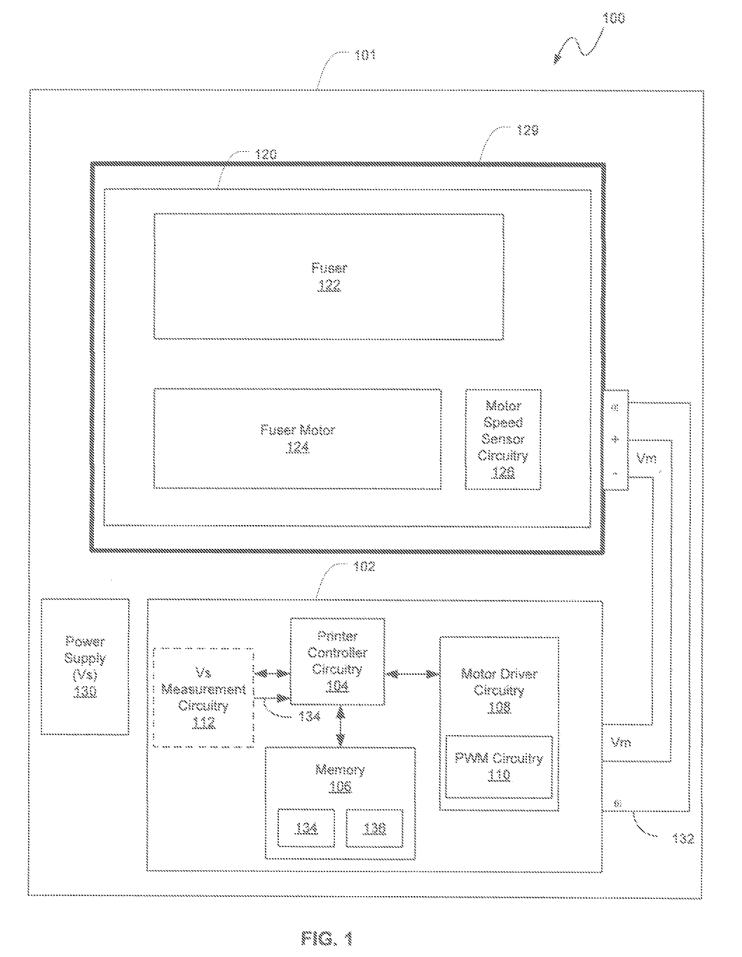

FIG. 1 depicts a laser printer system 100 consistent with one embodiment of this disclosure. Printer 100 may include a printer base 101, a print engine 102 and customer replaceable unit (CRU) 120. The CRU 120 may be a removable package and dimensioned to fit within a slot 129 of printer base 101 such that, when removably disposed within slot 129, the CRU 120 is mechanically coupled to the base 101 and electrically coupled to the print engine 102. The CRU 120 may include a fuse mechanism 122 configured to fuse toner to media and a fuser motor 124 configured to drive the fuser mechanism 122. The fuser motor 124 may include, for example, a brush DC motor and/or a brushless DC motor. The CRU 120 may also include motor speed sensor circuitry 126 configured to generate a signal (ω) indicative of, or proportional to , the speed (RPM) of the fuser motor 124. As a general overview, print engine 102 may be configured to detect at least one physical parameter of the fuser motor 124 and to control the operation of the fuser motor 124, based on, at least in part, the at least one physical parameter of the fuser motor 124.

Print engine 102 may include printer controller circuitry 104, memory 106 and motor driver circuitry 108. In one embodiment, memory 106 may be configured to store at least one control code set corresponding to the fuser motor 124. When executed by printer controller circuitry 104, the control code set may permit printer controller circuitry 104 to control the operation of the fuser motor 124. In this embodiment, memory 106 may be configured to store a first control code set 134 corresponding to a first type of fuser motor 124 and a second control code set 136 corresponding to second type of fuser motor 124. Based upon the type of fuser motor disposed within the CRU 120, the print engine 102 may select the appropriate control code set to control the operation of the fuser motor. “Control code set” may include, for example, one or more instructions that when executed by the printer controller circuitry 104 cause the print engine 102 to control the fuser motor 124.

Motor driver circuitry 108 may include pulse width modulation (PWM) circuitry 110. The pulse width modulation circuitry 110 may operate as DC to DC converter circuitry to generate a variable fuser motor DC power supply (Vm) based on a printer power supply 130 (Vs). As is understood in the art, PWM circuitry 110 may include at least one controllable switch (not shown). The duty cycle (p) of the at least one controllable switch may dictate the value (magnitude) of the DC power (Vm) generated by the motor driver circuitry 108. To that end, printer controller circuitry 104 may be configured to command the motor driver circuitry 108 to adjust the duty cycle of the PWM circuitry 110 to control the supply voltage Vm of the fuser motor 124. In addition, PWM circuitry 110 may be configured to control the value of Vm based on, at least in part, feedback information received from the fuser motor 124. For example, in this embodiment, fuser motor speed information (ω) 132 may be used by PWM circuitry 110 in a “closed-loop” manner to control the supply voltage Vm, which, in turn may be used to control the speed (ω) of the fuser motor 124.

In one embodiment, motor speed sensor circuitry 126 may include an optical rotational sensor (not shown) configured to sense rotation of a shaft of the fuser motor 124. Of course, motor speed sensor circuitry 126 may include other electrical and/or electro-mechanical rotational sensors, for example, capacitive rotational sensors, etc. As stated, motor speed sensor circuitry 126 configured to generate a signal (ω) indicative of, or proportional to, the speed (RPM) of the fuser motor 124. To that end, motor speed sensor circuitry 126 may include analog-to-digital circuitry configured to convert an analog signal generated by a rotational sensor to a digital signal, for example, a digital pulse train indicative of, or proportional to the motor speed ω.

In addition, printer controller circuitry 104 may be configured to detect at least one physical parameter of the fuser motor 124. A “physical parameter”, as used herein with respect to the fuser motor 124, may include, for example, torque constant, back-EMF constant, winding resistance, rotor inertia, and/or other detectable parameter associated with the motor 124. For example, in one embodiment, if print engine 102 senses that a new CRU 120 has been placed into slot 129 (via for example, a mechanical, electrical and/or electro-mechanical switch, not shown), the printer controller circuitry 104 may execute a detection operation to determine one or more physical parameters of the fuser motor 124. Alternatively or additionally, upon power-up or reset initialization of the print engine 102, the printer controller circuitry 104 may execute a detection operation to determine one or more physical parameters of the fuser motor 124.

The voltage, Vm, generated by print engine 102 and supplied to the fuser motor 124, may be represented by:

Vm=(K_{E}*ω)+((T_{g}/K_{T})*R); EQ. 1

where:

K_{E} is the motor back-EMF constant (V-sec/rad), ω is the motor speed (rad/sec), T_{g} is the total torque generated by the fuser motor (N−m), K_{T} is the motor torque constant (N−m/A) and R is the fuser motor resistance (Ohms).

The total torque generated by the fuser motor 124 may be represented by:

T_{g}=T_{L}+Tₐ+T_{f}+T_{D}; EQ: 2

where:

T_{L} is the load torque (N−m) of the fuser motor, Tₐ is the acceleration torque (N−m) of the fuser motor, T_{f} is the friction torque (N−m) of the fuser motor and T_{D} is the damping torque (N−m) of the fuser motor.

In one embodiment, printer controller circuitry 104 may command motor driver circuitry 108 to control the fuser motor 124 in a steady state mode so that the acceleration torque Tₐ is approximately zero. Furthermore, printer controller circuitry 104 may command motor driver circuitry 108 to control the fuser motor 124 to spin in both forward and reverse directions. The forward direction may engage the fuser 122 and/or one or more mechanical rollers (not shown) associated with the CRU 120. The reverse direction, referred to herein as the duplex direction, may disengage the fuser motor 124 from the fuser 122 and/or from one or more mechanical rollers (not shown) associated with the CRU 120, and thus, the damping loads on the motor 124 may be negligible. Accordingly, printer controller circuitry 104 may command motor driver circuitry 108 to control the fuser motor 124 to spin in a duplex direction, and as a result, the damping torque, T_{D}, may be assumed to be approximately zero. “Approximately zero” may be generally defined as a value near zero or a negligible value (e.g., within engineering tolerances of the components of FIG. 1).

As stated above, PWM circuitry 110 may adjust the duty cycle of the supply voltage 130 (Vs) to adjust the fuser motor voltage Vm. The duty cycle may be adjusted between, for example a minimum duty cycle of 0% and a maximum duty cycle of 100%. This range may be linearly segmented and represented by an arbitrary numeric scale, for example, 0 through z, where 0 represents a 0% duty cycle, z represents a 100% duty cycle and z/2 represents a 50% duty cycle. Of course, as stated, this is an arbitrary scale and any numeric range (as may be implemented by motor driver circuitry 108) may be used without departing from this embodiment. Thus, the fuser motor voltage Vm may also be represented by:

Vm=Vs*(p/P)−V_{D}; EQ. 3

where:

p is the PWM setting from 0 to z, P is the maximum PWM setting (z) and V_{D} is the voltage drop associated with motor driver circuitry 108. Depending on the type and efficiency of motor driver circuitry 108 used, in certain embodiments, the voltage drop (V_{D}) of the motor driver circuitry may be assumed to be approximately zero. Alternatively, for typical motor driver circuitry 108 operating at a duty cycle of less than 90% maximum, the voltage drop (V_{D}) of the motor driver circuitry may be assumed to be approximately constant.

Combining Equations 1, 2 and 3:

Vs*(p/P)−V_{D}=(K_{E}*ω)+(((T_{L}+T_{E})/K_{T})*R) EQ. 4

Equation 4 can be rearranged to solve for motor speed ω, as follows:

ω=(Vs/(K_{E}*P))*p−(V_{D}/K_{E})−((T_{L}+T_{f})/(K_{E}*K_{T}))*R EQ. 5

Equation 5 may represent the equation of a straight line, where (Vs/(K_{E}*P)) is the slope and (V_{D}/K_{E})−((T_{L}+T_{f})/(K_{E}*K_{T}))*R is the y-intercept. Accordingly, the slope of Equation 5 may be measured by using two different PWM values (e.g., p1 and p2) and measuring the corresponding motor speed values (e.g., ω1 and ω2).

The following example is directed to detection of a back-EMF constant of the fuser motor 124. The back-EMF constant may be indicative of the type and/or size of the fuser motor 124. Accordingly, detection of back-EMF may enable the print engine to determine the type of fuser motor 124 being used, and thus, implement a control process corresponding to the type of fuser motor.

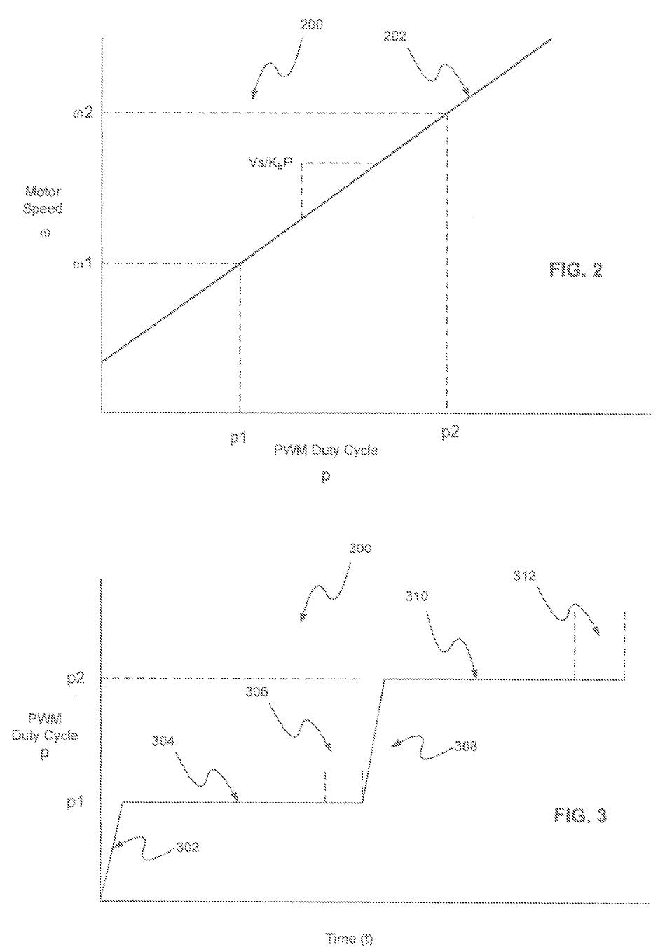

FIG. 2 depicts a graph 200 of motor speed (ω) as a function of PWM duty cycle settings (p) according to one exemplary embodiment of the present disclosure. With continued reference to FIG. 1, printer controller circuitry 104 may be configured to command motor driver circuitry 108 to set a first PWM duty cycle, p1, to generate a first fuser motor voltage Vm1. In response thereto, the fuser motor 124 may spin at a first motor speed ω1. Printer controller circuitry 104 may be configured to detect the first motor speed ω1 (as may be generated by motor speed sensor circuitry 126) corresponding to the first PWM duty cycle. Similarly, printer controller circuitry 104 may be configured to command motor driver circuitry 108 to set a second PWM duty cycle, p2, to generate a second fuser motor voltage Vm2, and in response thereto, the fuser motor 124 may spin at a second motor speed ω2. Printer controller circuitry 104 may be also configured to detect the second motor speed ω2 (as may be generated by motor speed sensor circuitry 126) corresponding to the second PWM duty cycle. These operations may generate the value of the slope of the line 202, represented by Equation 5 (above).

The slope of Equation 5 may be equated with the detected speed and PWM duty cycle settings, as follows:

(Vs/(K_{E}*P))=(ω2−ω1)/(p2−p1) EQ. 6

Equation 6 can be rearranged to solve for the back-EMF constant K_{E}, as follows:

K_{E}=((p2−p1)/(ω2−ω1))*(Vs/P) EQ. 7

Since the supply voltage Vs and the maximum duty cycle P that may be generated by PWM circuitry 110 may be known, printer controller circuitry 104 may be configured to generate the back-EMF value, K_{E}, based on the PWM settings p1 and p2 and the measured motor speed values ω1 and ω2. Based on the back-EMF value, printer controller circuitry 104 may select an appropriate control code set for the type of fuser motor 124 disposed within the CRU 120. To that end, memory 106 may include a look-up table (not shown) that correlates back-EMF values with a control code set, and printer controller circuitry 104 may select a control code set to control the fuser motor 124 by reading the appropriate control set in the look-up table. Of course, a look-up table is only an example of correlating a detected physical parameter (e.g., back-EMF) to an appropriate control code set (e.g., 134 and/or 136) to control the motor 124.

FIG. 3 depicts a graph 300 of PWM duty cycle settings (p) as a function of time (t) according to one exemplary embodiment of the present disclosure. In this example, the units of time (t) are arbitrary. With continued reference to FIGS. 1 and 2, during a first time interval 302, printer controller circuitry 104 may be configured to command motor driver circuitry 108 to ramp up to a first PWM duty cycle, p1. In this embodiment, and depending on the sensitivity of the components of FIG. 1, the duty cycle p1 may remain constant for a time period 304 to permit, for example, the motor speed to settle. During time period 306, printer controller circuitry 104 may be configured to measure the first motor speed ω1 corresponding to a first motor voltage Vm1. During a time period 308, printer controller circuitry 104 may be configured to command motor driver circuitry 108 to ramp up to a second PWM duty cycle, p2. The duty cycle p2 may remain constant for a time period 310 to permit, for example, the motor speed to settle. During time period 312, printer controller circuitry 104 may be configured to measure the second motor speed ω2 corresponding to a second motor voltage Vm2.

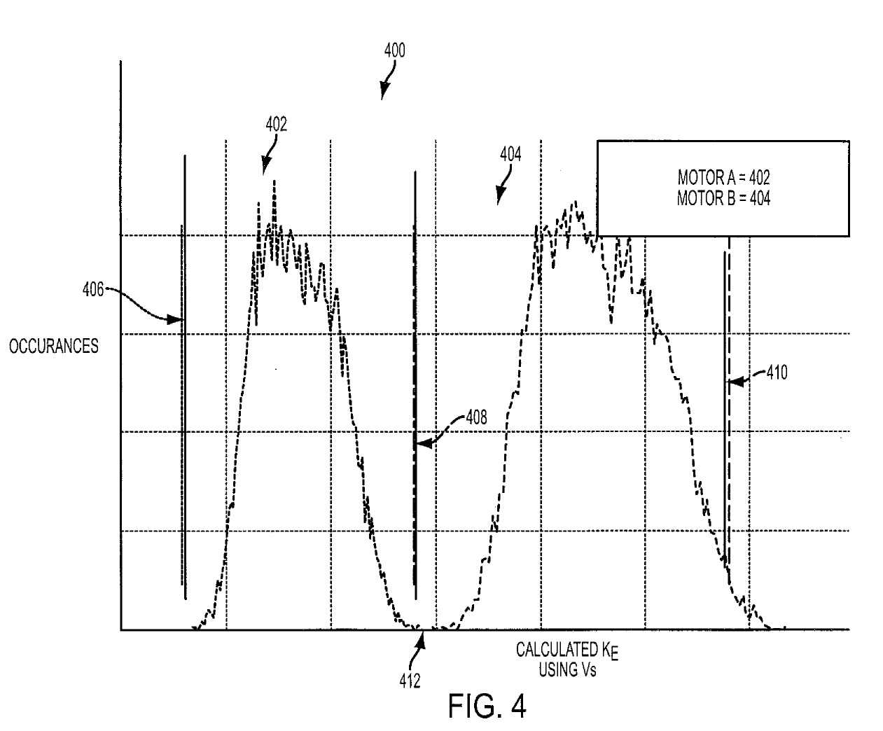

FIG. 4 depicts a graph 400 of generated back-EMF data. In particular, this graph depicts back-EMF data generated for two different fuser motors, e.g., Motor A 402 and Motor B 404. The x-axis of this graph 400 represents calculated values of K_{E} using Vs and the y-axis represents the occurrences (in arbitrary numbers) of those calculations. In this example, Motor B 404 generally has a larger back-EMF value than Motor A 402. In this embodiment, printer controller circuitry 104 may be configured to generate back-EMF values for Motor A 402 between a lower detection bound 406 and an upper detection bound 408. Similarly, printer controller circuitry 104 may be configured to generate back-EMF values for Motor B 404 between a lower detection bound 408 and an upper detection bound 410. While Motor A and Motor B may have distinct back-EMF values, the similarity of Motor A and Motor B may generate an overlap of back-EMF values, as depicted by overlap region 412. Thus, for example, if printer controller circuitry 104 commands motor driver circuitry 108 to operate Motor A and Motor B in the overlap region 412, printer controller circuitry may have difficulty distinguishing between Motor A and Motor B. Of course, this problem may be resolved by operating Motor A and Motor B in the middle region of each respective back-EMF curve, i.e., beteen lower bound 406 and upper bound 408 for Motor A and between lower bound 408 and upper bound 410 for Motor B.

In the previous example, the value of Vs 130 may be assumed constant or within a tolerance range. This may present detection problems, especially in the overlap region 412. Vs 130 may represent a generic power supply associated with the printer system 100, and may vary base on, for example, load conditions. Accordingly, in an alternative embodiment, the power supply Vs 130 may be measured to provide a more accurate value of the power supply voltage. This may enable, for example, a more accurate back-EMF calculation. Thus, and referring again to FIG. 1, another embodiment of the print engine 102 may include Vs (power supply) measurement circuitry 112. Vs measurement circuitry 112 may be configured to measure the value of Vs (130) and generate a measured power supply value (Vs′) 134. Vs measurement circuitry 112 may include, for example, voltage divider circuitry (not shown) and analog to digital (A/D) circuitry (not shown) configured to generate a digital value of Vs. In this embodiment, Vs′ may represent a more accurate value of the power supply 130.

Accordingly, Equation 7 may be rewritten to reflect a measured value of the power supply 130.

K_{E}=((p2−p1)/(ω2−ω1))*(Vs′/P) EQ. 8

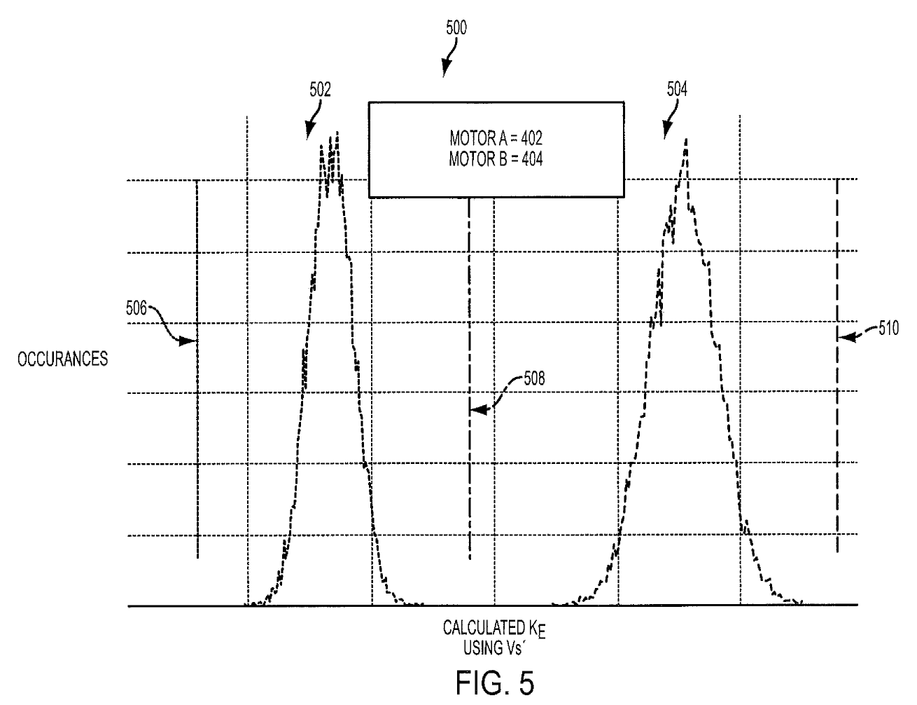

Using Vs′ may improve the separation between motors having similar back-EMF values (as described in FIG. 4), which may enable printer controller circuitry 104 to more accurately detect the type of motor installed in the CRU 120. For example, FIG. 5 depicts a graph 500 of generated back-EMF data for the two different fuser motors described above, i.e., Motor A and Motor B. The x-axis of this graph 500 represents calculated values of K_{E} using Vs′ and the y-axis represents the occurrences (in arbitrary number) of those calculations. In this example, the back-EMF values for Motor A are depicted in graph 502 and the back-EMF values for motor B are depicted in graph 504. In this embodiment, printer controller circuitry 104 may be configured to generate back-EMF values for Motor A 502 between a lower detection bound 506 and an upper detection bound 508. Similarly, printer controller circuitry 104 may be configured to generate back-EMF values for Motor B 504 between a lower detection bound 508 and an upper detection bound 510. As compared with the graph 400 of FIG. 4, a wider separation between the back-EMF values may be produced using the measured value of Vs (Vs′) to calculate the back-EMF values, set forth in Equation 8 above. During a motor detection operation, and referring again to FIG. 3, printer controller circuitry 104 may control Vs measurement circuitry 112 to read the measured power supply value 134, for example, during time periods 306 and 312.

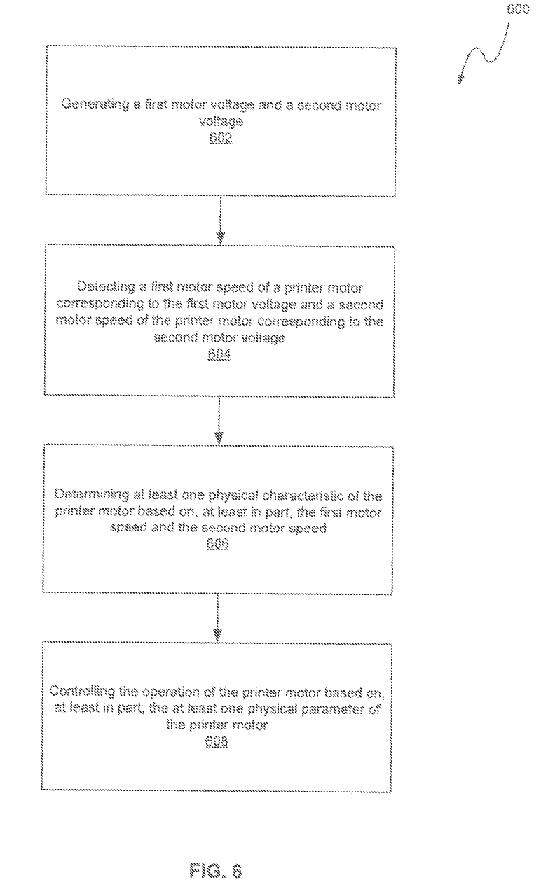

FIG. 6 illustrates a flowchart 600 of an exemplary motor detection process according to one embodiment. The method of this embodiment may include generating a first motor voltage and a second motor voltage 602. The method of this embodiment may also include detecting a first motor speed of a printer motor corresponding to the first motor voltage and a second motor speed of the printer motor corresponding to the second motor voltage 604. The method of this embodiment may further include, determining at least one physical characteristic of the printer motor based on, at least in part, the first motor speed and the second motor speed 606. The method of this embodiment may also include, controlling the operation of the printer motor based on, at least in part, the at least one physical parameter of the printer motor 608.

While the foregoing description of FIGS. 1-6 provides an example of determining a back-EMF constant based on motor speed and PWM settings, it should be readily apparent that printer controller circuitry 124 may be configured to detecting other physical parameters of the fuser motor 124. For example, printer controller circuitry 124 may be configured to detect the total motor torque (T_{g}) and/or the motor torque constant (K_{T}) and/or other physical parameters of the fuser motor 124 (for example, by rearranging terms in any of Equations 1 through 7). Further, while the foregoing description of FIG. 1 is in reference to detection of a fuser motor installed in a laser printer, it should be understood that the teachings provided herein may apply equally to any type of printer and printer motor. For example, the teachings of the present disclosure may be utilized to detect and control a motor associated with an inkjet printer, color laser printer, “all-in-one” unit, fax machine and/or other printing system.

The operative components of the print engine 102 of FIG. 1 may be implemented, for example, in an integrated circuit (IC) (or collection of ICs) which may include, for example, a System-on-a-Chip (SoC), an application specific integrated circuit (ASIC) and/or a field programmable gate array (FPGA). “Integrated circuit”m as used in any embodiment herein, means a semiconductor device and/or microelectronic device, such as, for example, but not limited to, a semiconductor integrated circuit chip. Of course, in other embodiments, the operative components may be implemented using discrete circuitry and/or a mixture of discrete circuitry and one or more integrated circuits. For example, motor driver circuitry 108 may be implemented using an ST Microelectronics TEA3718 motor controller and printer controller circuitry 104 may comprise a general-purpose processor programmed to perform the operations described herein.

As used in any embodiment described herein, “circuitry” may comprise, for example, singly or in any combination, hardwired circuitry, programmable circuitry, state machine circuitry, and/or firmware that stores instructions executed by programmable circuitry. Any of the operations and/or operative components described in any embodiment herein may be implemented in software, firmware, hardwired circuitry and/or any combination thereof.

Embodiments of the methods described above may be implemented in a computer program that may be stored on a storage medium having instructions to program a system (e.g., a machine) to perform the methods. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

Other embodiments may be implemented as software modules executed by a programmable control device. To that end, the methodology described herein for detection and control of a printer motor may be “offloaded”, at least in part, to a device external to the printer system 100. For example, the printer system 100 may be configured to communicate with a computer system (not shown) having a general-purpose processor and/or specific circuitry configured to perform one or more of the operations of the print engine 102 described herein.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A printer, comprising:
a motor; and
a print engine configured to:
generate a first motor voltage and a second motor voltage;
detect a first motor speed of said motor corresponding to said first motor voltage and a second motor speed of said motor corresponding to said second motor voltage;
determine at least one physical characteristic of said motor based on, at least in part, said first motor speed and said second motor speed; and
control the operation of said motor based on, at least in part, said at least one physical parameter of said motor.

2. The printer of claim 1, further comprising a customer replaceable unit (CRU), wherein said motor is configured to be disposed within said CRU; and a printer base, said CRU is configured to be removably coupled to said printer base.

3. The printer of claim 1, wherein said print engine comprises motor driver circuitry configured to generate a first pulse width modulation (PWM) duty cycle to generate said first motor voltage and a second PWM duty cycle to generate said second motor voltage.

4. The printer of claim 1, wherein said print engine comprises printer controller circuitry configured to execute a control code set, from among a plurality of control code sets, to control the operation of said motor; said printer controller circuitry is further configured to select said control code set, from among said plurality of control code sets, based on, at least in part, the at least one physical parameter of said motor.

5. The printer of claim 1, further comprising:
motor speed sensor circuitry configured to generate a signal indicative of, or proportional to, said first motor speed and said second motor speed.

6. The printer of claim 1, wherein said print engine further comprises supply voltage measurement circuitry configured to measure the value of a supply voltage supplied to said print engine, and wherein said print engine is further configured to determine the at least one physical parameter of said motor based on, at least in part, said measured supply voltage.

7. The printer of claim 1, wherein said at least one physical parameter of said motor includes a back-EMF constant.

8. The printer of claim 1, wherein said at least one physical parameter of said motor is selected from at least one of the group comprising a torque constant, a back-EMF constant, a winding resistance, and rotor inertia.

9. A method for determining a motor type installed in a printer, said method comprising:
generating a first printer motor voltage and a second printer motor voltage and supplying said first printer motor voltage and said second printer motor voltage to a printer motor;
detecting a first printer motor speed corresponding to said first printer motor voltage and a second printer motor speed corresponding to said second printer motor voltage;
determining at least one physical characteristic of said printer motor based on, at least in part, said first motor speed and said second motor speed; and
controlling the operation of said printer motor based on, at least in part, said at least one physical parameter of said printer motor.

10. The method of claim 9, further comprising:
generating a first pulse width modulation (PWM) duty cycle to generate said first motor voltage and a second PWM duty cycle to generate said second motor voltage.

11. The method of claim 9, further comprising:
generating a signal indicative of, or proportional to, said first motor speed and said second motor speed.

12. The method of claim 9, further comprising:
executing a control code set, from among a plurality of control code sets, to control the operation of said motor, and
selecting said control code set, from among said plurality of control code sets, based on, at least in part, the at least one physical parameter of said motor.

13. The method of claim 9, further comprising:
measuring the value of a supply voltage; and
determining the at least one physical parameter of said motor based on, at least in part, said measured supply voltage.

14. The method of claim 9, wherein:
said at least one physical parameter of said motor includes a back-EMF constant.

15. The method of claim 9, wherein:
said at least one physical parameter of said motor is selected from at least one of the group comprising a torque constant, a back-EMF constant, a winding resistance, and rotor inertia.

16. The method of claim 9, wherein:
said motor is configured to be disposed within a customer replaceable unit (CRU); and said CRU is configured to be removably coupled to a printer base.

17. An article, comprising:
a storage medium having stored thereon instructions that when executed by a machine result in the following:
generating a first printer motor voltage and a second printer motor voltage and supplying said first printer motor voltage and said second printer motor voltage to a printer motor;
detecting a first printer motor speed corresponding to said first printer motor voltage and a second printer motor speed corresponding to said second printer motor voltage;
determining at least one physical characteristic of said printer motor based on, at least in part, said first motor speed and said second motor speed; and
controlling the operation of said printer motor based on, at least in part, said at least one physical parameter of said printer motor.

18. The article of claim 17, wherein the instructions when executed by the machine also result in:
generating a first pulse width modulation (PWM) duty cycle to generate said first motor voltage and a second PWM duty cycle to generate said second motor voltage.

19. The article of claim 17, wherein the instructions when executed by the machine also result in:
generating a signal indicative of, or proportional to, said first motor speed and said second motor speed.

20. The article of claim 17, wherein the instructions when executed by the machine also result in:
executing a control code set, from among a plurality of control code sets, to control the operation of said motor; and
selecting said control code set, from among said plurality of control code sets, based on, at least in part, the at least one physical parameter of said motor.

21. The article of claim 17, wherein the instructions when executed by the machine also result in:
measuring the value of a supply voltage; and
determining the at least one physical parameter of said motor based on, at least in part, said measured supply voltage.

22. The article of claim 17, wherein:
said at least one physical parameter of said motor includes a back-EMF constant.

23. The article of claim 17, wherein:
said at least one physical parameter of said motor is selected from at least one of the group comprising a torque constant, a back-EMF constant, a winding resistance, and rotor inertia.
